(19) United States
(12) Patent Application Publication
(10) Pub. No.: US 2017/0259301 A1
(43) Pub. Date: Sep. 14, 2017

(54) COATING SYSTEM AND METHOD OF FORMING A CURED FILM ON AN ALUMINUM SUBSTRATE

(71) Applicant: GM GLOBAL TECHNOLOGY OPERATIONS LLC, Detroit, MI (US)

(72) Inventors: Hua-tzu Fan, Troy, MI (US); Jorge F. Arinez, Rochester Hills, MI (US)

(73) Assignee: GM GLOBAL TECHNOLOGY OPERATIONS LLC, Detroit, MI (US)

(21) Appl. No.: 15/452,846

(22) Filed: Mar. 8, 2017

Related U.S. Application Data
(60) Provisional application No. 62/306,902, filed on Mar. 11, 2016.

(51) Int. Cl. B05D 7/14; B05D 3/10; B05D 3/00; B05D 1/18; C23G 1/22; C23G 1/12

(52) U.S. Cl. CPC B05D 7/14; C23G 1/22; C23G 1/125; B05D 3/007; B05D 1/18; B05D 3/102

(57) ABSTRACT

A method of forming a cured film on an aluminum substrate includes depositing a film formed from a sol-gel coating composition onto the aluminum substrate without disposing a conversion coating composition onto the aluminum substrate. The method also includes, after depositing, curing the film. A coating system includes an aluminum substrate having a surface and a cured film disposed on and in contact with the surface. The cured film is formed from a sol-gel coating composition. The coating system is free from a layer formed from a conversion coating composition.

### CROSS-REFERENCE TO RELATED APPLICATIONS

This application claims the benefit of U.S. Provisional Patent Application No. 62/306,902, filed Mar. 11, 2016, which is hereby incorporated by reference in its entirety.

### INTRODUCTION

The disclosure relates to a coating system and to a method of forming a cured film on an aluminum substrate.

Components formed from metal often require protection from degradation caused by exposure to environmental conditions. For example, components formed from aluminum may be coated with one or more films or layers to promote adhesion between the aluminum and the one or more films and to provide the component with protection from corrosion.

### SUMMARY

A method of forming a cured film on an aluminum substrate includes depositing a film formed from a sol-gel coating composition onto the aluminum substrate without disposing a conversion coating composition onto the aluminum substrate. The method also includes, after depositing, curing the film.

In one aspect, depositing may include immersing the aluminum substrate in the sol-gel coating composition. In another aspect, depositing may include dip-coating the aluminum substrate. Further, depositing may include not converting the aluminum substrate via a chemical reaction to a layer that includes a compound of the aluminum substrate. Depositing may include not converting the aluminum substrate via an electrochemical reaction to a layer that includes a compound of the aluminum substrate.

In a further aspect, curing may include baking the film in an oven for a duration of from 10 minutes to 40 minutes. In another aspect, curing may include drying the film in air at ambient temperature for a duration of from 5 minutes to 48 hours.

In another embodiment, the method includes cleaning the aluminum substrate to form a clean surface, depositing a film formed from a sol-gel coating composition onto the clean surface without disposing a conversion coating composition onto the aluminum substrate, and curing the film.

In one aspect, cleaning may include spray washing the aluminum substrate. In another aspect, cleaning may include dipping the aluminum substrate in an alkaline cleaner. In a further aspect, the method may further include, after cleaning, pickling the clean surface with an acid to form a prepared surface.

A coating system includes an aluminum substrate having a surface and a cured film disposed on and in contact with the surface. The cured film is formed from a sol-gel coating composition. The coating system is free from a layer formed from a conversion coating composition.

In one aspect, the coating system is free from a layer formed from an electrodeposition coating composition. The cured film may be free from a layer that includes a compound of the aluminum substrate formed via a chemical reaction between the aluminum substrate and a conversion coating composition. The cured film may be free from a layer that includes a compound of the aluminum substrate and a conversion coating composition.

In another aspect, the sol-gel coating composition is a sol-gel nanocomposite coating composition. In a further aspect, the sol-gel coating composition is silicone-based. In yet another aspect, the sol-gel coating composition includes tetraethyl orthosilicate; a polar, protic solvent; and a polar, aprotic solvent.

The aluminum substrate may be formed from an aluminum alloy and the cured film may have a thickness of from 10 microns to 40 microns.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic illustration of a perspective view of a coating system.

FIG. 2 is a schematic illustration of a cross-sectional view of the coating system of FIG. 1.

FIG. 3 is a flowchart of a method of forming a cured film on an aluminum substrate.

### DETAILED DESCRIPTION

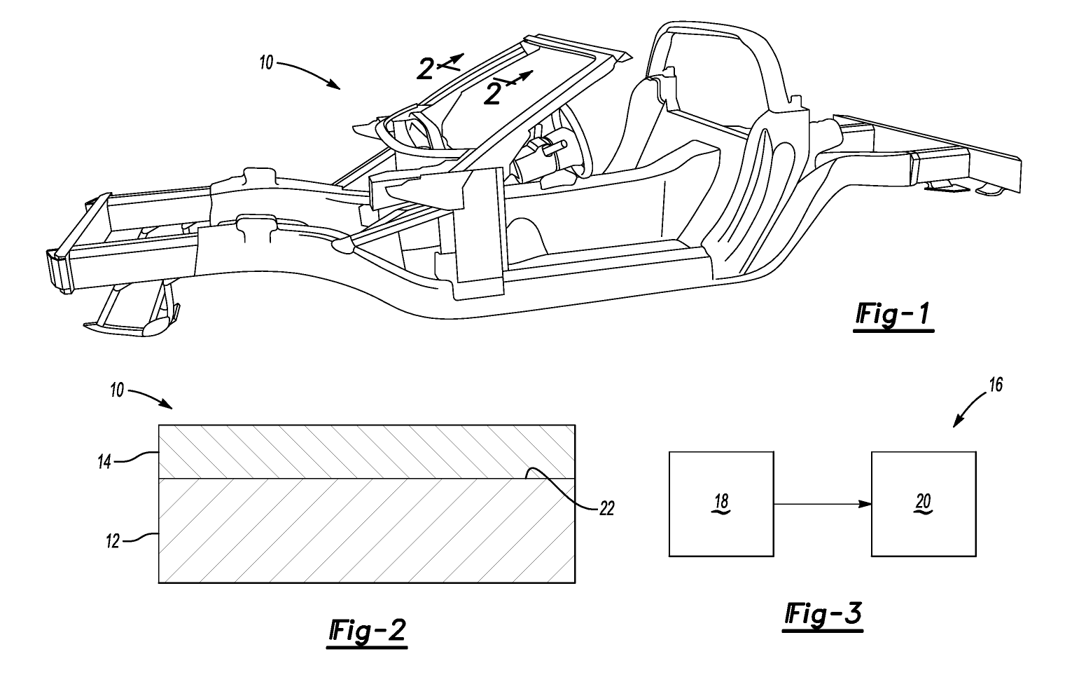

Referring to the Figures, wherein like reference numerals refer to like elements, a coating system 10 is shown generally in FIGS. 1 and 2. The coating system 10 may be suitable for applications in which an aluminum substrate 12 requires protection from corrosion caused by exposure to environmental conditions, e.g., humidity, salt, contaminants, etc. More specifically, the coating system 10 may be useful for components that require corrosion protection without the use of an adhesion-promoting film, a foundation layer, and/or a protective film formed from a conversion coating composition. Further, the coating system 10 may be free from a layer formed from an electrodeposition coating composition, i.e., an e-coat. That is, for the coating system 10, a cured film 14 disposed on an aluminum substrate 12 and formed from a sol-gel coating composition replaces a layer formed from a conversion coating composition and a layer formed from an electrodeposition coating composition, as set forth in more detail below.

Therefore, the coating system 10 may be useful for automotive applications such as, but not limited to, vehicle frames and support structures, vehicle components, and vehicle tooling. For example, the coating system 10 may be useful for an automotive space frame formed from aluminum. Alternatively, the coating system 10 may be useful for non-automotive applications such as, but not limited to, aerospace and aviation components, construction applications, packaging, chemical processing equipment, food and beverage processing equipment, power transmission applications, appliances, furniture, medical devices, and industrial vehicles.

Referring now to FIG. 3, a method 16 of forming the cured film 14 (FIG. 2) on the aluminum substrate 12 (FIG. 2) includes depositing 18 a film formed from a sol-gel coating composition onto the aluminum substrate 12 without disposing a conversion coating composition onto the aluminum substrate 12. That is, the cured film 14 formed from the sol-gel coating composition eliminates or replaces a layer formed from a conversion coating composition.

More specifically, the method 16 does not include treating the aluminum substrate 12 with a conversion coating composition, such as, but not limited to, conversion coating compositions commercially available under the trade name Alodine® from Henkel Corporation of Rocky Hill, Conn. As used herein, the terminology conversion coating composition refers to a coating composition that is suitable for converting the aluminum substrate 12 via a chemical reaction or an electrochemical reaction to a protective layer that includes a compound of the aluminum substrate 12 at a surface 22 of the aluminum substrate 12. That is, conversion coating compositions generally convert the surface 22 of the aluminum substrate 12 to a protective layer. However, for the method 16, depositing 18 may include not converting the aluminum substrate 12 via a chemical reaction to a layer that includes a compound of the aluminum substrate 12. Similarly, depositing 18 may include not converting the aluminum substrate 12 via an electrochemical reaction to a layer that includes a compound of the aluminum substrate 12. Other conversion coating compositions may include zinc phosphate or zirconium oxide. However, the method 16 may not include treating the aluminum substrate 12 with zinc phosphate or zirconium oxide.

Instead, depositing 18 may include immersing the aluminum substrate 12 in the sol-gel coating composition to coat the aluminum substrate 12 with the sol-gel coating composition. For example, depositing 18 may include dip-coating the aluminum substrate 12 in a tank that contains the sol-gel coating composition.

The sol-gel coating composition may be a sol-gel nanocomposite coating composition. The sol-gel coating composition may be silicone-based. For example, the sol-gel coating composition may include tetraethyl orthosilicate; a polar, protic solvent; and a polar, aprotic solvent. In addition, the cured film 14 formed from the sol-gel coating composition may be transparent. Further, the sol-gel coating composition may provide the aluminum substrate 12 with excellent corrosion-resistance, adhesion to subsequent coating layers, such as a basecoat and/or a clearcoat, and excellent protection from ultraviolet radiation. Suitable sol-gel coating compositions are commercially available from Advenira Enterprise, Inc. of Sunnyvale, Calif. and Coval Molecular Coatings of Petaluma, Calif.

Referring again to FIG. 3, the method 16 also includes, after depositing 18, curing 20 the film. For example, curing 20 may include baking the film in an oven for a duration of from 10 minutes to 40 minutes. Alternatively, curing 20 may include drying the film in air at ambient temperature for a duration of from 5 minutes to 48 hours. That is, curing 20 may occur at room temperature and may eliminate baking the film in an oven. Therefore, the method 16 may be useful for large components that are not suitably sized for oven baking.

In another embodiment, the method 16 includes cleaning the aluminum substrate 12 to form a clean surface. For example, cleaning may include spray washing the aluminum substrate 12 to remove oil or contaminants. Alternatively or additionally, cleaning may include dipping the aluminum substrate 12 in an alkaline cleaner.

For this embodiment, after cleaning, the method 16 may include pickling the clean surface with an acid to form a prepared surface. Pickling may strip off any aluminum oxide layer formed on the aluminum substrate 12. Suitable examples of an aqueous acid for pickling the clean surface include nitric acid 10% in concentration by volume and sulfuric acid 20% in concentration by volume. Further, the method 16 includes depositing 18 the film formed from the sol-gel coating composition onto the prepared surface without disposing a conversion coating composition onto the aluminum substrate 12, and curing 20 the film.

In yet another embodiment, the method 16 may not include pickling the clean surface. That is, for this embodiment, the method 16 includes cleaning the aluminum substrate 12 to form the clean surface, depositing 18 the film formed from the sol-gel coating composition onto the clean surface without disposing a conversion coating composition onto the aluminum substrate 12, and curing 20 the film. In particular, for embodiments including the silicone-based sol-gel coating composition, the silicone-based sol-gel coating composition may form the film on the aluminum substrate 12 through Al—O—Si covalent bonds. As such, it may not be necessary to strip off any aluminum oxide layer formed on the aluminum substrate 12 by pickling the clean surface. Rather, Al—O—Si covalent bonds may instead form directly on the aluminum oxide layer and bond the sol-gel coating composition to the aluminum substrate 12.

Referring again to FIG. 2, the coating system 10 includes the aluminum substrate 12 having the surface 22, and the cured film 14 disposed on and in contact with the surface 22. The aluminum substrate 12 may be formed from pure aluminum or may be formed from an aluminum alloy. The cured film 14 is formed from the sol-gel coating composition and may have a thickness of from 10 microns to 40 microns, e.g., from 10 microns to 20 microns, wherein 1 micron is equivalent to 1×10−6 meters.

The coating system 10 is free from a layer formed from a conversion coating composition. That is, the cured film 14 may be free from a layer that includes a compound of the aluminum substrate 12 formed via a chemical reaction between the aluminum substrate 12 and a conversion coating composition. Similarly, the cured film 14 may be free from a layer that includes a compound of the aluminum substrate 12 formed via an electrochemical reaction between the aluminum substrate 12 and a conversion coating composition. Alternatively or additionally, the coating system 10 may be free from a layer formed from an electrodeposition coating composition, i.e., an e-coat.

The method 16 and coating system 10 are cost-effective. That is, the method 16 eliminates the application of an adhesion promoting layer, i.e., a conversion coating, and eliminates the application of an electrodeposition layer, i.e., an e-coat, to the surface 22 of the aluminum substrate 12. Therefore, the cured film 14 formed from the sol-gel coating composition replaces a layer formed from a conversion coating composition and a layer formed from an electrodeposition coating composition. In addition, for some embodiments, the method 16 may eliminate pickling and/or oven baking. As such, the method 16 simplifies a manufacturing process for components requiring aluminum substrates 12 that are protected from corrosion and degradation.

In addition, the cured film 14 formed from the sol-gel coating composition is inherently stable with respect to ultraviolet radiation and can therefore resist degradation caused by exposure to sunlight. Further, since the cured film 14 may be transparent, the cured film 14 may enhance the aesthetics of the coating system 10.

While the best modes for carrying out the disclosure have been described in detail, those familiar with the art to which this disclosure relates will recognize various alternative designs and embodiments for practicing the disclosure within the scope of the appended claims.

What is claimed is:

1. A method of forming a cured film on an aluminum substrate, the method comprising:
depositing a film formed from a sol-gel coating composition onto the aluminum substrate without disposing a conversion coating composition onto the aluminum substrate; and
after depositing, curing the film.

2. The method of claim 1, wherein depositing includes immersing the aluminum substrate in the sol-gel coating composition.

3. The method of claim 1, wherein depositing includes dip-coating the aluminum substrate.

4. The method of claim 1, wherein depositing includes not converting the aluminum substrate via a chemical reaction to a layer that includes a compound of the aluminum substrate.

5. The method of claim 1, wherein depositing includes not converting the aluminum substrate via an electrochemical reaction to a layer that includes a compound of the aluminum substrate.

6. The method of claim 1, wherein curing includes baking the film in an oven for a duration of from 10 minutes to 40 minutes.

7. The method of claim 1, wherein curing includes drying the film in air at ambient temperature for a duration of from 5 minutes to 48 hours.

8. A method of forming a cured film on an aluminum substrate, the method comprising:
cleaning the aluminum substrate to form a clean surface;
depositing a film formed from a sol-gel coating composition onto the prepared surface without disposing a conversion coating composition onto the aluminum substrate; and
curing the film.

9. The method of claim 8, wherein cleaning includes spray washing the aluminum substrate.

10. The method of claim 8, wherein cleaning includes dipping the aluminum substrate in an alkaline cleaner.

11. The method of claim 8, further including, after cleaning, pickling the clean surface with an acid to form a prepared surface.

12. A coating system comprising:
an aluminum substrate having a surface; and
a cured film disposed on and in contact with the surface, wherein the cured film is formed from a sol-gel coating composition;
wherein the coating system is free from a layer formed from a conversion coating composition.

13. The coating system of claim 12, wherein the coating system is free from a layer formed from an electrodeposition coating composition.

14. The coating system of claim 12, wherein the cured film is free from a layer that includes a compound of the aluminum substrate formed via a chemical reaction between the aluminum substrate and a conversion coating composition.

15. The coating system of claim 12, wherein the cured film is free from a layer that includes a compound of the aluminum substrate formed via an electrochemical reaction between the aluminum substrate and a conversion coating composition.

16. The coating system of claim 12, wherein the sol-gel coating composition is a sol-gel nanocomposite coating composition.

17. The coating system of claim 12, wherein the sol-gel coating composition is silicone-based.

18. The coating system of claim 12, wherein the sol-gel coating composition includes tetraethyl orthosilicate; a polar, protic solvent; and a polar, aprotic solvent.

19. The coating system of claim 12, wherein the aluminum substrate is formed from an aluminum alloy.

20. The coating system of claim 12, wherein the cured film has a thickness of from 10 microns to 40 microns.
